(19) United States
(12) Patent Application Publication
(10) Pub. No.: US 2010/0087094 A1
(43) Pub. Date: Apr. 8, 2010

(54) Connector And Circuit Board For Multiple Transmission Interfaces

(75) Inventors: Shou-Yi Chen, Banciao (TW); Mei-Chuan Yu, Banciao (TW); Tien-Fu Cheng, Banciao (TW)

Correspondence Address: T-CONN PRECISION CORP., P.O. BOX 11192, TAIPEI, 10099, TW

(73) Assignee: T-CONN PRECISION CORPORATION, BANCIAO (TW)

(21) Appl. No.: 12/245,739

(22) Filed: Oct. 4, 2008

(51) Int. Cl. H01R 13/648; H01R 27/02

(52) U.S. Cl. 439/607.01; 439/638

(57) ABSTRACT

A connector and circuit board suitable for multiple transmission interfaces, which can be applied to storage devices or computer devices is disclosed. The connector device includes a connector case, and two transmission interfaces respectively disposed on upper and lower sides of the connector case. One end connector case serves to electrically connect with the circuit board, and another end serves as the transmission interfaces complying with at least two different specifications. Thus, the users may select suitable transmission interface according to actual needs.

### FIELD OF THE INVENTION

The present invention relates a connector and circuit board for multiple transmission interfaces; and more particularly to a connector and circuit board complying with multiple transmission specifications.

### BACKGROUND OF THE INVENTION

As information and network technologies rapidly develop and prevail in various industries, the amount of data required to be handled and transferred by each person everyday becomes ever incessantly more and more; especially upon emergence of audio/video technology digitalization, the size of each digital audio/video file (e.g. DVD-related files) can be typically of hundreds of megabytes (MB) or sometimes of several gigabytes (GB), resulting in even higher demand for hard disk drive of large capacity.

Current storage device industry keeps developing hard disc drives of ultra high density to deal with the storage of enormous amount of data, still such a demand can not satisfy the increasing demand in that, conventional storage devices mostly adopt the data transmission interface of IDE specification (hereunder referred as the IDE transmission interface), the maximum transmission speed for an interface of the IDE specification is 33.3 MB/sec. During the past days when capacity of a hard disc drive might reach merely hundreds of MB or thousands of MB, this specification was indeed relatively fast, thus was sufficiently rapid; however, current hard disc drives may provide capacities of hundreds or even thousands of GB, in contrast, the IDE transmission interface has now become a comparatively slow transmission interface. In addition, the IDE transmission interface itself does not provide features of Hot Plug and Plug & Play, which is not suitable for being used as a portable hard disc drive.

For such reasons, two types of ultra high speed transmission specifications have been developed recently, namely the Universal Serial Bus (USB) and the Serial Advanced Technology Attachment (SATA), in which the former latest released USB 3.0 version, whose maximum transmission speed may exceed 480 MB/sec; the latter latest MicroSATA version, whose maximum transmission speed is over 3 GB/sec. Both provide features of Hot Plug and Plug & Play, accordingly rapidly replace the earlier IDE transmission interface.

However, in the prevalent market, release time of USB transmission interface is earlier than SATA, whose prevalence rate reaches nearly 90%; while although the development of SATA transmission interface is later, with lower popularity, its transmission speed is nevertheless 7 times faster than USB transmission interface. Besides, MicroSATA provides a feature of less consumption on system performance. But, generally speaking, each has its own unique characteristics.

Accordingly, how to effectively combine the advantages of prevalence and high transmission speed offered by the two aforementioned transmission interfaces, allowing users to select suitable transmission interface based on actual requirement is the issue to which the present invention is directed.

### SUMMARY OF THE INVENTION

The objective of the present invention is to provide a connector and circuit board suitable for multiple transmission interfaces, which can be applied to storage devices or computer devices such as hard disc drive, portable micro memory device or desktop computer, notebook computer and so forth. The connector device comprises a connector case, wherein one end thereof serves to electrically connect to the circuit board, and the other end thereof serves as transmission interfaces of at least two different specifications, namely the first transmission interface and the second transmission interface. The transmission interfaces are separately installed on the upper and lower side of the connector case.

Thus, the connector device and the circuit board of the present invention can provide multi-functional features and high transmission speed, allowing users to select suitable transmission interface according to actual needs.

According to an aspect of the present invention, a first transmission interface is disposed on the upper side of the connector case and a second transmission interface is disposed on the lower side of the connector case. A slot base is disposed on the other end of the connector case, and a first interface socket and a second interface socket are disposed on a bottom of the slot base. A first guiding bar and a second guiding bar are respectively disposed on two sides of the slot base, wherein the first guiding bar is located on the exterior side of the first interface socket and the second guiding bar is located on the exterior side of the second interface socket so as to guide the plug to be inserted into the connector along the corresponding guiding bar.

According to an aspect of the present invention, the first transmission interface or the second transmission interface complies with transmission interface specifications such as SATA, ESATA, MicroSATA, USB, miniUSB or MicroUSB.

### BRIEF DESCRIPTION OF THE DRAWINGS

FIG. 1-1 shows a perspective view of male and female connectors of a connector and circuit board suitable for multiple transmission interfaces according to an embodiment of the present invention.

FIG. 1-2 illustrates a back view of the male and female connectors of the connector and circuit board suitable for multiple transmission interfaces according to an embodiment the present invention.

FIG. 2-1 illustrates a plan view of the male and female connectors of the connector and circuit board usable for multiple transmission interfaces according to an embodiment of the present invention.

FIG. 2-2 illustrates a back plan view of the male and female connectors of the connector and circuit board suitable for multiple transmission interfaces according to an embodiment of the present invention.

FIG. 3-1 illustrates a front view of dissembled conventional MicroSATA male and female mating components of storage device.

FIG. 3-2 illustrates a side view of dissembled conventional MicroSATA male and female mating components of storage device.

FIG. 3-3 illustrates a front view of dissembled conventional MicroSATA male and female mating components of storage device.

FIG. 3-4 illustrates a back view of dissembled conventional MicroSATA male and female mating components of storage device.

FIG. 3-5 illustrates back view of dissembled conventional MicroSATA male and female mating components of storage device when viewed at another angle.

FIG. 4-1 illustrates a front view of mated conventional male and female components of MicroSATA of storage device with a computer device.

FIG. 4-2 illustrates a side view of mated conventional male and female components of MicroSATA of storage device with a computer device.

FIG. 4-3 illustrates a front stereo view of mated conventional male and female components of MicroSATA of storage device with a computer device.

FIG. 4-4 illustrates a back stereo view of mated conventional male and female components of MicroSATA of storage device with a computer device.

FIG. 4-5 illustrates a back view of mated conventional male and female components of MicroSATA of storage device with a computer device when viewed at at another angle.

FIG. 5-1 illustrates a front view of dissembled MicroSATA male and female mating components of the storage device and a computer device according to an embodiment of the present invention.

FIG. 5-2 illustrates a side view of dissembled MicroSATA male and female mating components of the storage device and a computer device according to an embodiment of the present invention.

FIG. 5-3 illustrates a back view of dissembled MicroSATA male and female mating components of the storage device and a computer device according to an embodiment of the present invention.

FIG. 5-4 illustrates a front view of dissembled MicroSATA male and female mating components of the storage device and a computer device according to an embodiment of the present invention.

FIG. 5-5 illustrates a back view of dissembled MicroSATA male and female mating components of the storage device and a computer device according to an embodiment of the present invention.

FIG. 6-1 illustrates a front view of mated MicroSATA male and female mating components of the storage device with a computer device according to an embodiment of the present invention.

FIG. 6-2 illustrates a side view of mated MicroSATA male and female mating components of the storage device with a computer device according to an embodiment of the present invention.

FIG. 6-3 illustrates a back view of mated MicroSATA male and female mating components of the storage device with a computer device according to an embodiment of the present invention.

FIG. 6-4 illustrates a front stereo view of mated MicroSATA male and female mating components of the storage device with a computer device according to an embodiment of the present invention.

FIG. 7-1 illustrates a front view of dissembled USB male and female mating components of the storage device and a computer device according to an embodiment of the present invention.

FIG. 7-2 illustrates a side view of dissembled USB male and female mating components of the storage device and a computer device according to an embodiment of the present invention.

FIG. 7-3 illustrates a back view of dissembled USB male and female mating components of the storage device and a computer device according to an embodiment of the present invention.

FIG. 7-4 illustrates a front stereo view of dissembled USB male and female mating components of the storage device and a computer device according to an embodiment of the present invention.

FIG. 7-5 illustrates a back stereo view of dissembled USB male and female mating components of the storage device and a computer device according to an embodiment of the present invention.

FIG. 8-1 illustrates a front view of mated USB male and female components of the storage device with a computer device according to an embodiment of the present invention.

FIG. 8-2 illustrates a side view of mated USB male and female components of the storage device with a computer device according to an embodiment of the present invention.

FIG. 8-3 illustrates a front view of mated USB male and female components of the storage device with a computer device according to an embodiment of the present invention.

FIG. 8-4 illustrates a back view of mated USB male and female components of the storage device with a computer device according to an embodiment of the present invention.

FIG. 9-1 illustrates a front view of dissembled male and female connector components according to another embodiment of the present invention.

FIG. 9-2 illustrates a side view of dissembled male and female connector components according to another embodiment of the present invention.

FIG. 9-3 illustrates a back view of dissembled male and female connector components according to another embodiment of the present invention.

FIG. 9-4 illustrates a front view of dissembled male and female connector components according to another embodiment of the present invention.

FIG. 9-5 illustrates a back view of dissembled male and female connector components according to another embodiment of the present invention.

FIG. 9-6 illustrates a front view diagram of dissembled male and female connector components when viewed at another angle according to another embodiment of the present invention.

FIG. 9-7 illustrates a back view of dissembled male and female connector components when viewed at another angle according to another embodiment of the present invention.

FIG. 10-1 illustrates a front view of mated male and female connector components according to another embodiment of the present invention.

FIG. 10-2 illustrates a side view of mated male and female connector components according to another embodiment of the present invention.

FIG. 10-3 illustrates a back view of mated male and female connector components according to another embodiment of the present invention.

FIG. 10-4 illustrates a front stereo view of mated male and female connector components according to another embodiment of the present invention.

FIG. 10-5 illustrates a back view of mated male and female connector components according to another embodiment of the present invention.

### DETAILED DESCRIPTION

The technical means taken by the present invention to achieve the aforementioned objectives, as well as effects thereof, will be hereunder illustrated in details through the preferred embodiment of the present invention in conjunction with the appended drawings.

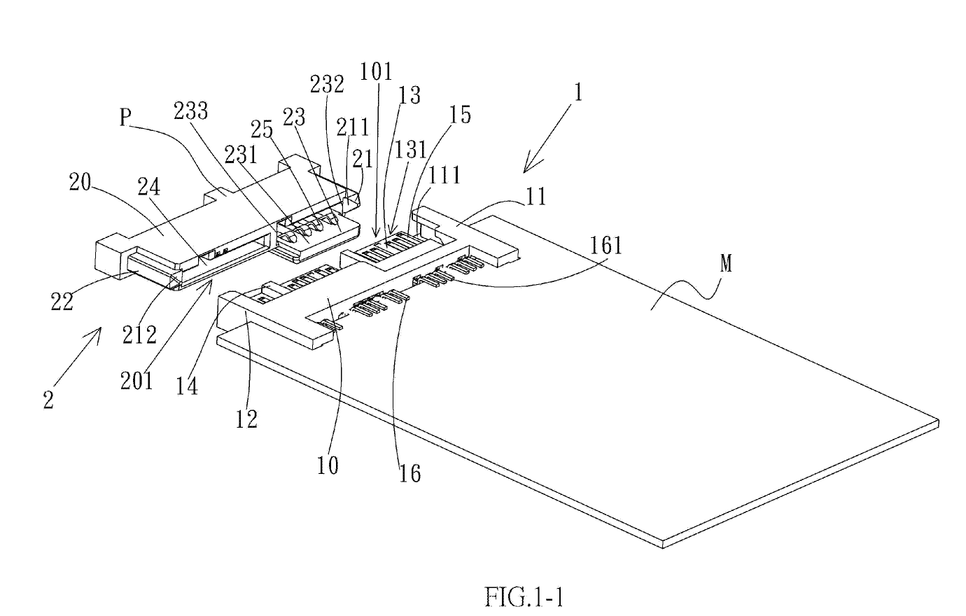

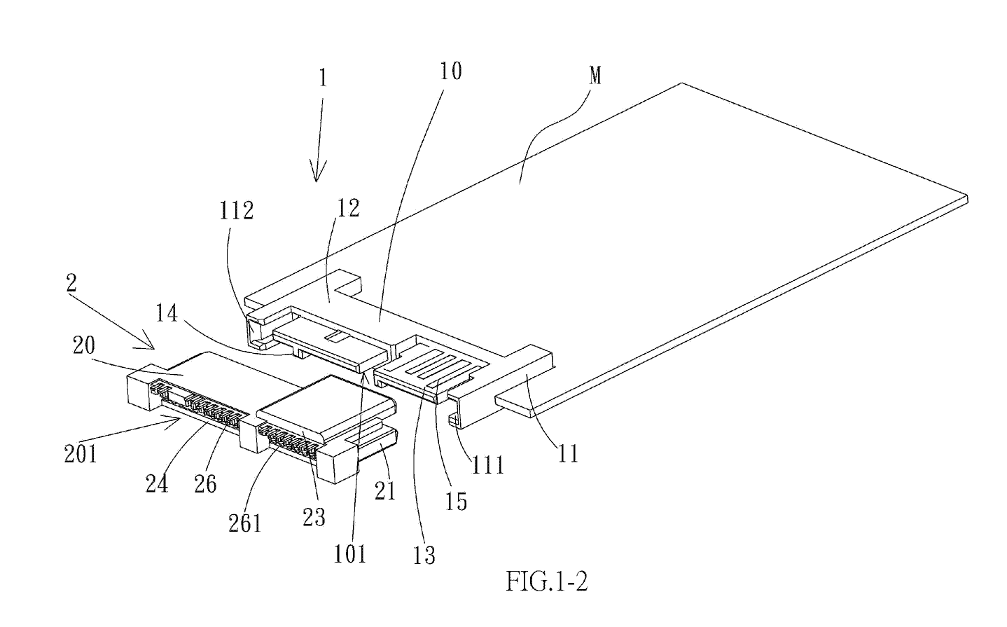

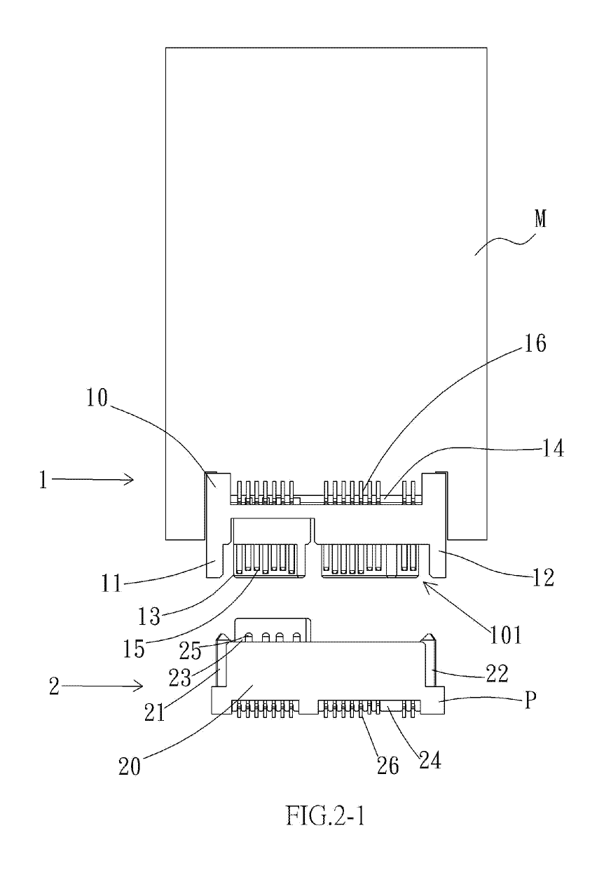

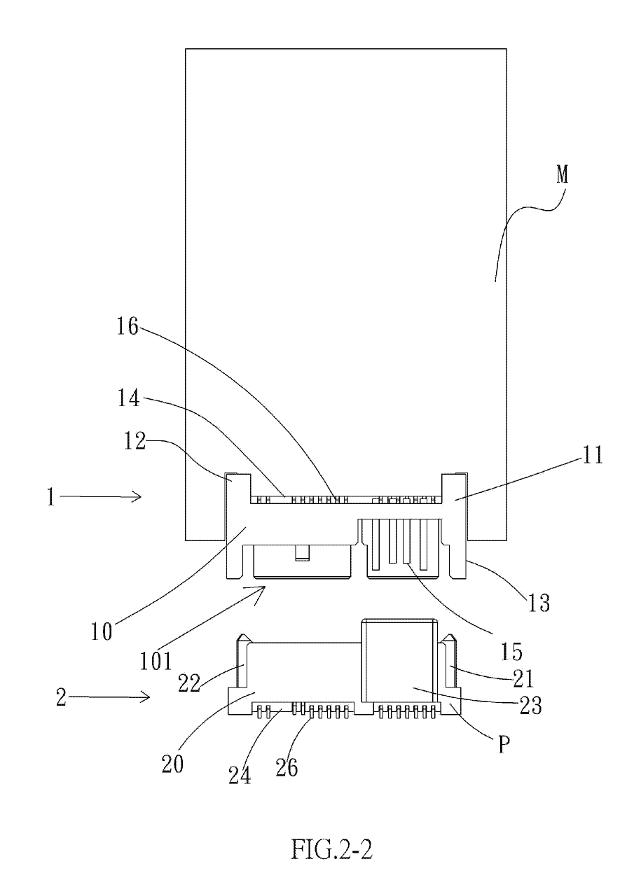

FIG. 1-1 illustrates a view of a male connector suitable for multiple transmission interfaces according to an embodiment of the present invention. FIG. 1-2 illustrates a back view of the male connector suitable for multiple transmission interfaces when viewed at another angle according to an embodiment of the present invention. FIG. 2-1 illustrates a plan view of the male connector according to an embodiment of the present invention. FIG. 2-2 illustrates a back plan view of the male connector according to an embodiment of the present invention.

Referring to FIGS. 1-1, 1-2, 2-1 and 2-2, a connector suitable for multiple transmission interfaces, which can be applied to a storage device M or a control circuit board P installed with a read device, for example, circuit boards on a hard disc drive external connection case, computer device or CD/DVD drive is provided. The male connector 1 comprises a connector case 10, a first transmission interface 15 disposed on a lower side thereof, and a second transmission interface 16 disposed on an upper side thereof One end of the second transmission interface may serve to electrically connect to the storage device M. Types and materials of the circuit boards are not restricted in the present invention; in the present embodiment, a portable micro memory device is taken as an example of the storage device M. A slot base 101 is disposed on another side of the connector case, and a first interface socket 13 and a second interface 14 having at least two different specifications are disposed in the slot base 101. The first transmission interface 15 is disposed in the first interface socket 13. An accommodation section 131 capable of receiving the USB terminal set is disposed in the first interface socket 13. The accommodation section 131 is formed in a recess formed on the lower surface of the case, and accommodation section 131 comprises a plurality of recesses capable of receiving USB terminals. The first transmission interface 15 is disposed on a lower side of the connector case 10 located on the same side of the communication end 161 of the MicroSATA terminal set relatively disposed on the upper side, and the second transmission interface 16 is disposed in the second interface socket 14. The first and second transmission interfaces may be SATA, ESATA, MicroSATA, USB, miniUSB or MicroUSB transmission interfaces, which is determined based on actual needs. Similarly, the terminal structure and number of arrangement in such transmission interfaces all depend on the type and specification of the corresponding transmission interface. For example, if the first transmission interface 15 follows USB specification, then the terminal structure and arrangement thereof have to comply with officially published USB regulations. If the second transmission interface 16 adopts MicroSATA specification, then the structure of the transmission interface terminal set must comply with officially published MicroSATA regulations.

Referring again to FIGS. 1-1 and 1-2, according to an embodiment of the present invention, a first guiding bar 11 and a second guiding bar 12 are respectively disposed on the two sides of the slot base of the connector case 10, wherein the first guiding bar 11 is located on an exterior side of the first interface socket 13, and the second guiding bar 12 is located on an exterior side of the second interface socket 14. A first guiding track 111 and a second guiding track 112 are respectively disposed on the interior sides of the guiding bars to guide the socket of the circuit board P to be precisely and smoothly inserted into the first interface socket 13 or the second interface socket 14. When a user intends to use the first interface socket 13, the user may precisely insert the socket into the first interface socket 13 along the first guiding track 111; and when the user intends to use the second interface socket 14, the user may precisely insert the socket into the second interface socket 14 along the second guiding track 112.

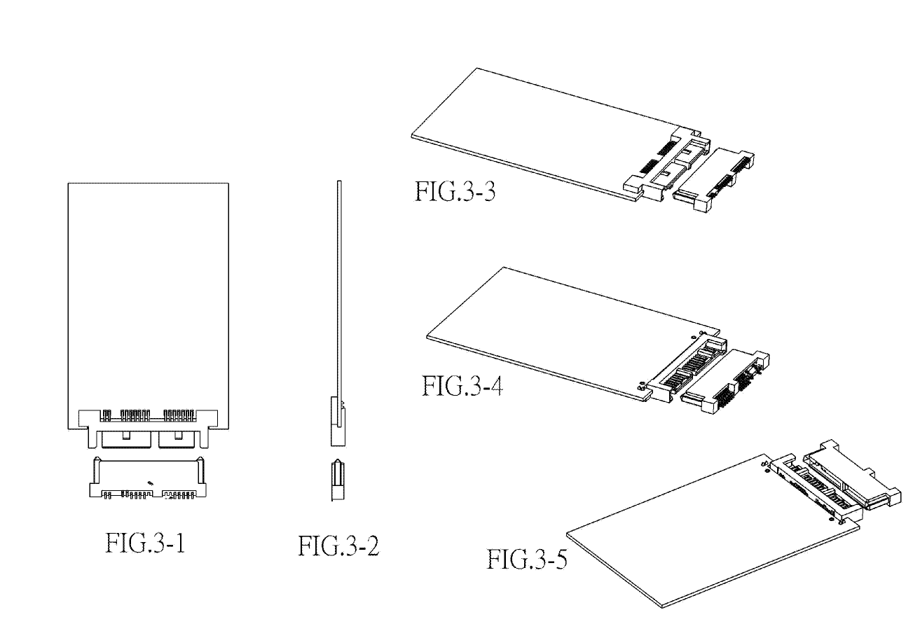

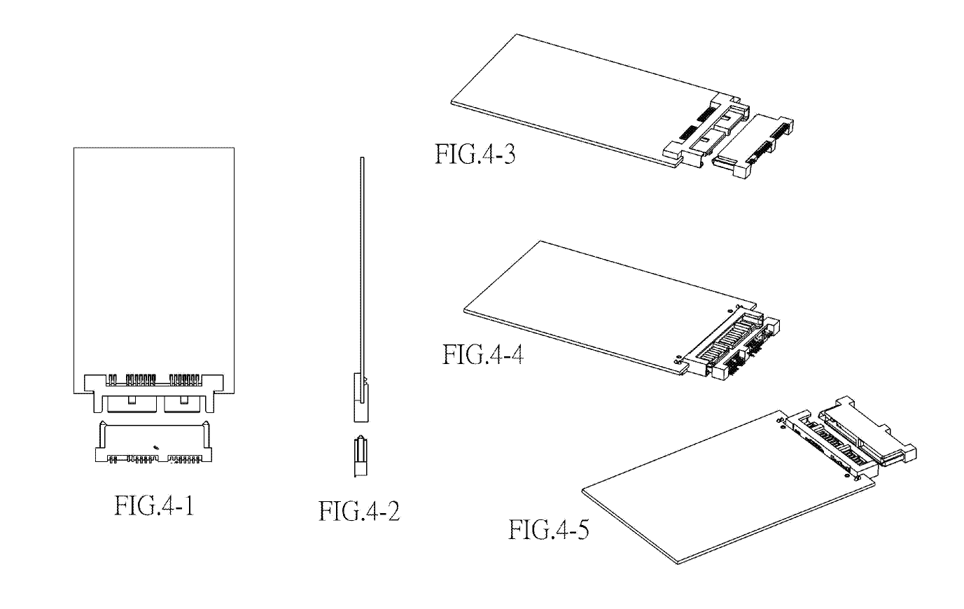

FIG. 3 illustrates a view of dissembled conventional MicroSATA male and female mating components applied in PC, NB computer circuit boards, of storage device. FIGS. 4 illustrates a view of mated conventional male and female components of MicroSATA of storage device and circuit board.

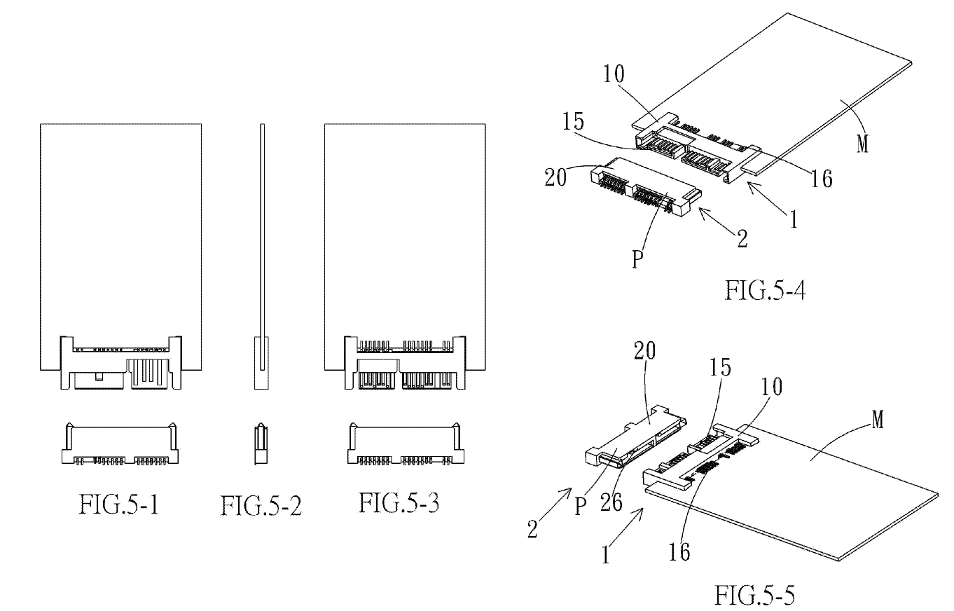

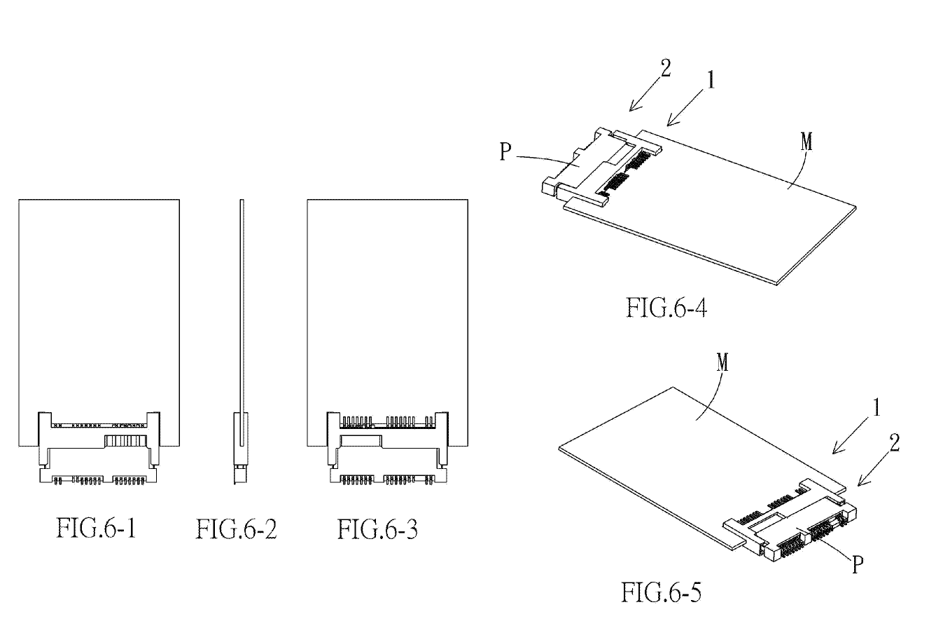

FIG. 5 illustrates a view of dissembled MicroSATA male and female mating components of the female connector according to an embodiment of the present invention. As illustrated in FIGS. 5-4, the terminal set of USB transmission interface 15 is disposed on a lower side of the connector case 10, and can be inserted into and electrically connected with the USB transmission interface of the computer device P. As illustrated in FIG. 5-5, the terminal set of MicroSATA transmission interface 16 is disposed on an upper side of the connector case 10, and can be inserted into and electrically connected with the MicroSATA transmission interface of the computer device P, wherein the number of terminals and arrangement thereof in the terminal set can be correspondingly adapted to the specification of the connectedly inserted MicroSATA terminal set. The embodiment illustrated in Figure uses the MicroSATA transmission interface in the storage device M applied to the male connector 1 in the connector and circuit board suitable for multiple transmission interfaces of the present invention. FIG. 6 illustrates a view of mated MicroSATA male and female mating components with the computer device P according to an embodiment of the present invention.

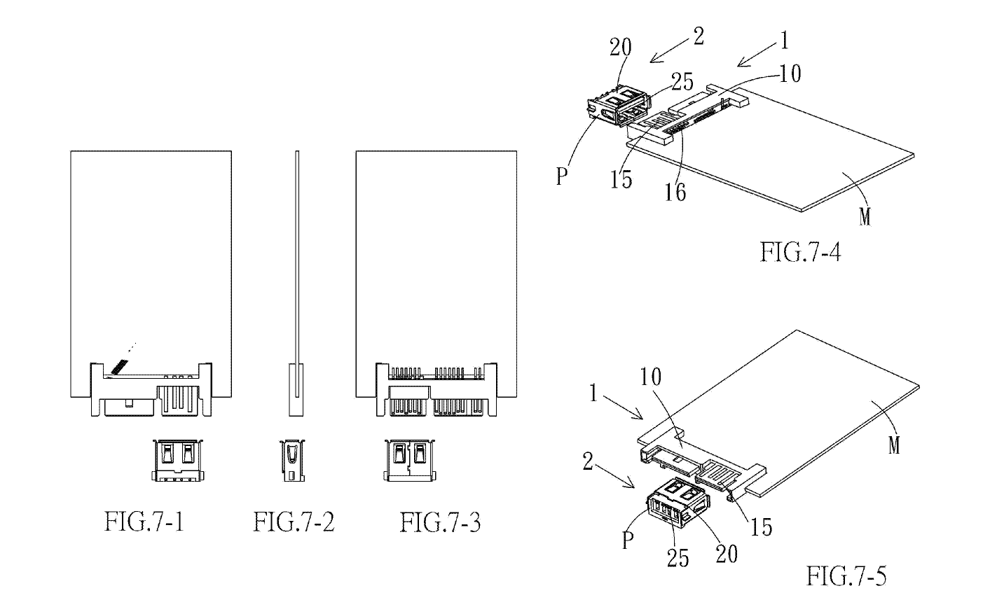

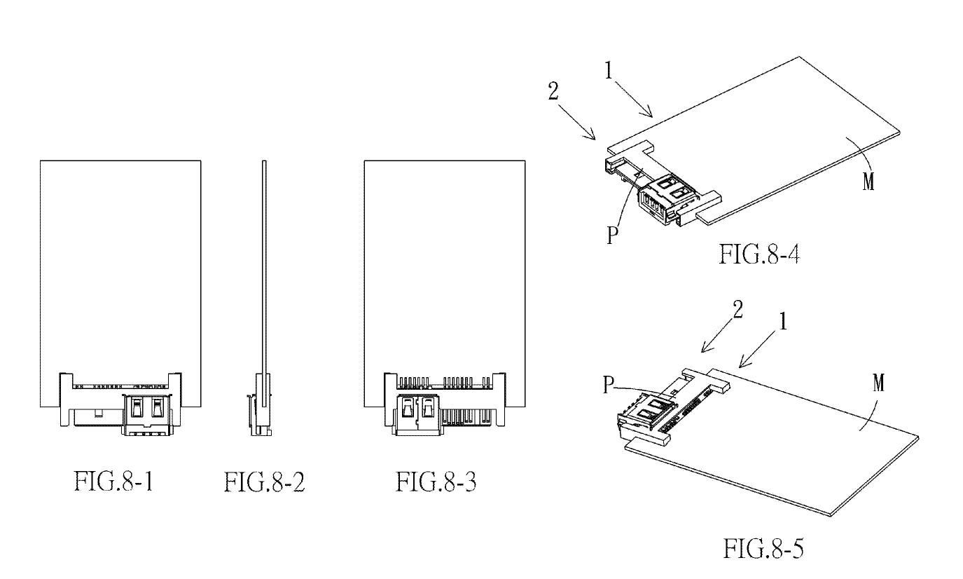

FIG. 7 illustrates a view of dissembled USB male and female mating components and the computer device P according to an embodiment of the present invention. As illustrated in FIG. 7-4, the terminal set of USB transmission interface 15 is disposed on a lower side of the connector case 10, and can be plugged into the USB transmission interface on a computer device P, wherein the specification of the terminal set is adapted to fit in the specification of the USB terminal set which can be 4 pins or 7 pins, and the terminal set may be fixed terminal or non-fixed terminal. In the present embodiment a 4-pin non-fixed terminal set is taken as example. As illustrated in FIG. 7-5, the terminal set of MicroSATA transmission interface 16 (not shown) is disposed on an upper side of the connector case 10, and may be insertion into and electrically connected with the MicroSATA transmission interface in the computer device P. In the present embodiment, the MicroSATA transmission interface in the storage device M applied to the male connector 1 in the connector and circuit board suitable for multiple transmission interfaces of the present invention. FIGS. 8 illustrates a view of a mated male and female mating components with the computer device P according to an embodiment of the present invention.

Referring to FIGS. 1-1 and 1-2, a female connector 2 correspondingly mating with the male connector 1 according to an embodiment of the present invention is illustrated, wherein the female connector 2 is disposed in the circuit board of the computer device P, and comprises a connector case 20, a first transmission interface 25 disposed on a lower side thereof and a second transmission interface 26 disposed on an upper side thereof. One end of the female connect may be electrically connected to the circuit board of the computer device P. Types and materials of the circuit board are not restricted in the present invention. The present embodiment takes a circuit board P in a computer device such as NB or PC as an example for illustration. A slot base 21 is disposed at another end of the weight scale 20, and a first interface socket 23 and a second interface socket 24 having at least two different specifications is disposed in the slot base 21, and a first transmission interface 25 is disposed in the first interface socket 23 formed on a lower surface of the connector case 2 by a protrusive slat structure 231 and two sidewalls 232 and 233. The slat structure 231 comprises a plurality of recesses capable of receiving USB terminals, and can be inserted into the accommodation section 131 of the male connector. The first transmission interface is disposed on a lower side of the connector case located on the same side of the communication end 261 of the MicroSATA terminal set relatively disposed on the upper side, and the second transmission interface 26 is disposed in the second interface socket 24. The first and second transmission interfaces can be respectively SATA, ESATA, MicroSATA, USB, miniUSB or MicroUSB transmission interfaces, which is determined based on actual needs. Similarly, the terminal structure and number of arrangement in such transmission interfaces all depend on the type and specification of the corresponding transmission interface. For example, if the first transmission interface 25 follows USB specification, then the structure and arrangement of each terminal in the transmission interface have to comply with officially published USB regulations; and if the second transmission interface 26 adopts MicroSATA specification, then the structure of the transmission interface terminal set must comply with officially published MicroSATA regulations.

Referring to FIGS. 1-1 and 1-2, according to the present invention, a first guiding bar 21 and a second guiding bar 22 are correspondingly disposed on two sides of the slot base of the connector case 20, wherein the first guiding bar 21 is located on an exterior side of the first interface socket 23, and the second guiding bar 22 is located on an exterior side of the second interface socket 24. A first guiding track 211 and a second guiding track 212 are correspondingly disposed on the interior sides of the first and second guiding bars for guiding the socket of the storage device M to be precisely and smoothly inserted into the first interface socket 23 or the second interface socket 24. When a user intends to use the first interface socket 23, the user may precisely insert the socket into the first interface socket 23 along the first guiding track 211; when the user intends to use the second interface socket 24, the user may precisely insert the socket into the second interface socket 24 along the second guiding track 212.

FIG. 5 illustrates a view of dissembled male and female mating components with the storage device M according to an embodiment of the present invention. As shown in FIG. 5-4, the terminal set of USB transmission interface (not shown) is disposed on a lower side of the connector case 20, and can be inserted into and electrically connected to the USB transmission interface of the computer device P. As illustrated in FIG. 5-5, the terminal set of MicroSATA transmission interface 26 is disposed on an upper side of the connector case 20, and can be inserted into and electrically connected to the MicroSATA transmission interface of the storage device M, wherein the number of terminals and arrangement thereof in the terminal set can be correspondingly adapted to the specification of the connectedly inserted MicroSATA terminal set. The embodiment illustrated in Figure uses the MicroSATA transmission interface in the computer device P applied to the male connector 1 in the connector and circuit board usable for multiple transmission interfaces of the present invention. FIG. 6 illustrates a view of mated MicroSATA male and female mating components with the storage device M according to an embodiment of the present invention.

FIG. 7 illustrates a view of dissembled USB male and female mating components and the storage device according to an embodiment of the present invention. As illustrated in FIG. 7-4, the terminal set of USB transmission interface 25 is disposed on a lower side of the connector case 20, and can be plugged into the USB transmission interface on a storage device M, wherein the specification of the terminal set is adapted to fit in the specification of the USB terminal set which can be 4 pins or 7 pins, and the terminal set may be fixed terminal or non-fixed terminal. The embodiment illustrated in Figure uses a 4-pin non-fixed terminal set. As illustrated in FIG. 7-5, the terminal set of MicroSATA transmission interface (not shown) is disposed on an upper side of the connector case 20, and can be inserted into and electrically connected with the MicroSATA transmission interface in the storage device M. The embodiment illustrated in Figure uses the MicroSATA transmission interface in the computer device P applied to the female connector in the connector and circuit board suitable for multiple transmission interfaces of the present invention. FIG. 8 illustrates a view of mated male and female mating components with the storage device M according to the present invention.

Furthermore, the first transmission interfaces disposed with USB, miniUSB or MicroUSB terminal set in the embodiments of the present invention are all disposed on a lower side of the male or female connector case, and the second transmission interfaces disposed with SATA, ESATA or MicroSATA terminal set are all disposed on an upper side of the male or female connector case. For the purpose of concise illustration, in certain drawings of the present invention, the first transmission interface located on the lower side of the case is reversely placed on the upper side, while the second transmission interface located on the upper side of the case is reversely placed on the lower side.

In addition, the male connector 1 and female connector 2, according to an embodiment of the present invention, can be also used as the connector for converter of transmission lines.

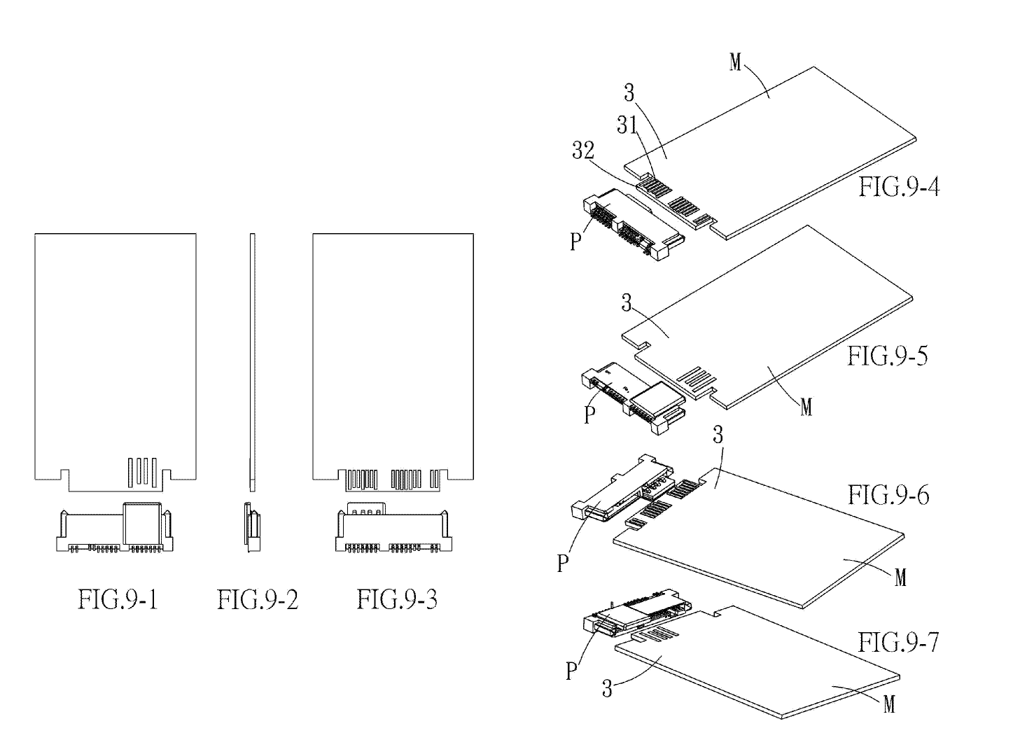

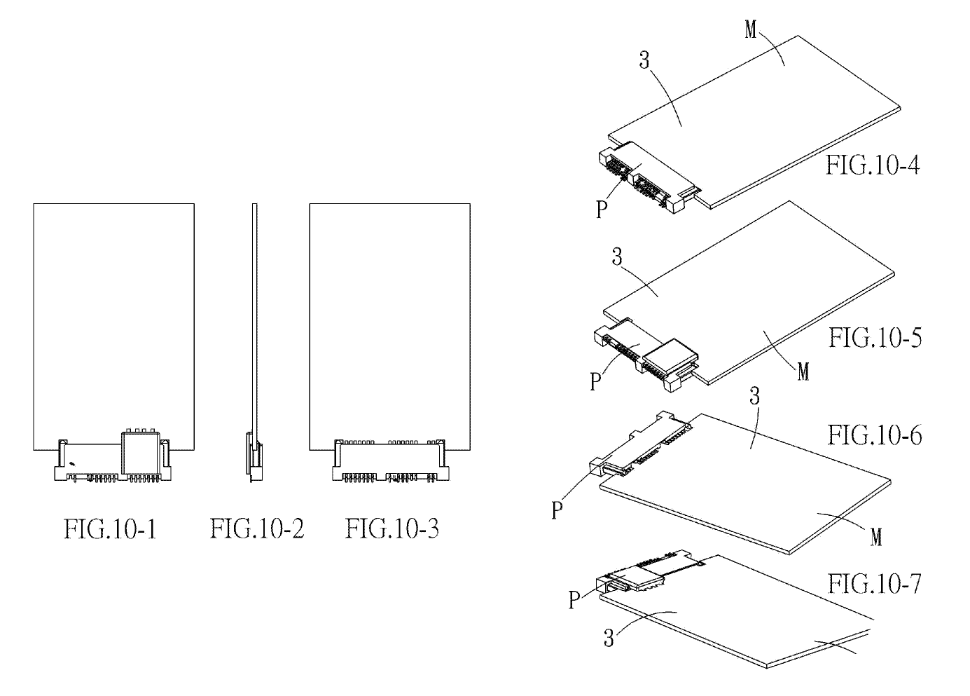

FIG. 9 illustrates a view of dissembled male and female connector components according to another embodiment of the present invention; and FIGS. 10-1 to 10-5 illustrates a view of mated male and female connector components according to another embodiment of the present invention.

As illustrated in FIG. 9-4, the line 31 at the front end of the circuit board 3 of a portable micro memory device M can be directly inserted into and electrically connected to the terminal set of the female connector case 1, in order to be directly connected in insertion to the female connector 2 of above-mentioned PC, NB or converter; that is, the protrusion structure 32 can be directly inserted into and electrically connected to the female connector 2, allowing the line 31 to conduct to the terminal set of the connector, thus forming an all-in-one structure of the circuit board and the connector.

In summary, the connector device suitable for multiple transmission interfaces provides multi-function features including comprehensive prevalence and high transmission performance, enabling users to select among different transmission interfaces.

The aforementioned descriptions are directed to set forth the preferred embodiments of the present invention, rather than being used to restrict the scope of the present invention. All changes and modifications made based on the shapes, structures, characters and concepts illustrated in the present disclosure should be deemed to fall within the scope of the present invention delineated by the following claims.

### Description of Component Symbols in Drawings

1 Male Connector
10 Connector Case
101 Slot Base
11 First Guiding Bar
111 First Guiding Track
112 Second Guiding Track
12 Second Guiding Bar
13 First Interface Socket
131 Accommodation Section
14 Second Interface Socket
15 First Transmission Interface
16 Second Transmission Interface
161 Communication End
M Storage Device
P Computer Device
2 Female Connector
Connector Case
Slot Base
21 First Guiding Bar
211 First Guiding Track
212 Second Guiding Track
22 Second Guiding Bar
23 First Interface Socket
231 Slat Structure
232 Sidewall
233 Sidewall
23 Second Interface Socket
25 First Transmission Interface
26 Second Transmission Interface
261 Communication End
3 Circuit Board
31 Lines
32 Protrusion Structure

### Description of Major Component Symbols

### Assigned Major Diagram: FIG. 1-1

1 Male Connector
10 Connector Case
11 First Guiding Bar
12 Second Guiding Bar
13 First Interface Socket
14 Second Interface Socket
15 First Transmission Interface
16 Second Transmission Interface
M Storage Device
P Computer Device
2 Female Connector
20 Connector Case
21 First Guiding Bar
22 Second Guiding Bar
23 First Interface Socket
24 Second Interface Socket
25 First Transmission Interface
26 Second Transmission Interface

1. A connector suitable for multiple transmission interfaces comprising a first connector and a second connector, the first connector comprising:
a connector case, having one end thereof electrically connected to the circuit board; and
a first transmission interface and a second transmission interface formed on another end of the connector case, wherein the first and second transmission interfaces are respectively disposed on an upper side and an lower side of the connector case.

2. The connector for multiple transmission interfaces as claimed in claim 1, wherein a slot base is disposed on another end of the connector case of the first connector, and the first and second transmission interfaces are disposed inside the slot base.

3. The connector suitable for multiple transmission interfaces as claimed in claim 1, wherein an accommodation section capable of receiving first transmission interface disposed on a lower side of the connector case of the first connector, wherein the accommodation section is formed in a recess formed on a lower surface of the connector case, and comprises a plurality of recesses capable of receiving first transmission interface.

4. The connector suitable for multiple transmission interfaces as claimed in claim 1, wherein the first transmission interface of the first connector is disposed on a lower side of the connector case located on a same side of a communication end of the second transmission interface relatively disposed on the upper side.

5. The connector suitable for multiple transmission interfaces as claimed in claim 2, wherein a first guiding bar and a second guiding bar are formed on the two sides of the slot base of the first connector.

6. The connector suitable for multiple transmission interfaces as claimed in claim 1, wherein a transmission interface formed by USB or miniUSB or MicroUSB terminal set is disposed on a lower side of the connector case.

7. The connector suitable for multiple transmission interfaces as claimed in claim 1, wherein a transmission interface formed by SATA or ESATA or MicroSATA terminal set is disposed on an upper side of the connector case.

8. The connector suitable for multiple transmission interfaces as claimed in claim 1, wherein the first connector is suitable for portable micro memory devices.

9. A connector suitable for multiple transmission interfaces comprising a first connector and a second connector, the second connector comprising:
a connector case, comprising one end thereof is electrically connected to a circuit board; and
a first transmission interface and a second transmission interface complying with at least two different specifications are formed at another end thereof, wherein the first and second transmission interfaces are respectively disposed on an upper side and a lower side of the connector case.

10. The connector suitable for multiple transmission interfaces as claim 9, wherein a slot base is disposed on another end of the connector case of the second connector, and the first and second transmission interfaces are disposed inside the slot base.

11. The connector suitable for multiple transmission interfaces as claimed in claim 9, wherein a socket capable of receiving first transmission interface is disposed on a lower side of the connector case of the second connector, wherein the socket is formed on a lower surface of the connector case by a protrusive slat structure and two sidewalls, and a plurality of recesses capable of receiving first transmission interface is disposed on slat structure; and wherein the slat structure is connected in insertion to the accommodation section of a first connector.

12. The connector suitable for multiple transmission interfaces as claimed in claim 9, wherein the first transmission interface of the second connector is installed on a lower side of the connector case which is located on a same side of a communication end of the second transmission interface relatively disposed on the upper side.

13. The connector suitable for multiple transmission interfaces as claimed in claim 9, wherein a first guiding bar and a second guiding bar are disposed on two sides of the slot base of the second connector.

14. The connector suitable for multiple transmission interfaces as claimed in claim 9, wherein a transmission interface formed by USB or miniUSB or MicroUSB terminal set disposed on a lower side of the connector case.

15. The connector suitable for multiple transmission interfaces as claimed in claim 9, wherein a transmission interface formed by SATA or ESATA or MicroSATA terminal set is disposed on an upper side of the connector case.

16. The connector suitable for multiple transmission interfaces as claimed in claim 9, wherein the second connector is suitable for computer devices.

17. The connector suitable for multiple transmission interfaces as claimed in claim 1, wherein the first and second connectors are suitable for converters of transmission lines.

18. A circuit board suitable for multiple transmission interfaces a protrusion structure at a front end thereof capable of being directly inserted into a second connector.

19. The circuit board suitable for multiple transmission interfaces as claimed in claim 18, wherein circuit board lines are formed on the protrusion structure.
